(19) United States
(12) Patent Application Publication
(10) Pub. No.: US 2012/0150776 A1
(43) Pub. Date: Jun. 14, 2012

(54) ADAPTIVE MULTIMEDIA PROCESSOR AND ADAPTIVE DATA PROCESSING METHOD

(75) Inventors: Yil Suk YANG, Daejeon (KR); Jongdae KIM, Daejeon (KR); Jung Hee SUK, Daejeon (KR); Sewan HEO, Daejeon (KR)

(73) Assignee: ELECTRONICS AND TELECOMMUNICATIONS RESEARCH INSTITUTE, Daejeon (KR)

(21) Appl. No.: 13/287,142

(22) Filed: Nov. 2, 2011

(30) Foreign Application Priority Data
Dec. 9, 2010 (KR) 10-2010-0125290

(51) Int. Cl. G06F 15/18

(52) U.S. Cl. 706/13

(57) ABSTRACT

Disclosed is a structure of an adaptive multimedia processor and a method for implementing an adaptive data processing algorithm. The adaptive multimedia processor includes a bit stream analyzer for analyzing bit stream information of multimedia data, and a bit stream learning device for converting multimedia data having a format which cannot be reproduced in a device, to multimedia data having a format which can be reproduced in a device, through an execution of a learning algorithm, based on an analysis by the bit stream analyzer.

### CROSS-REFERENCE TO RELATED APPLICATIONS

This application is based on and claims priority from Korean Patent Application No. 10-2010-0125290, filed on Dec. 9, 2010, with the Korean Intellectual Property Office, the disclosure of which is incorporated herein in its entirety by reference.

### BACKGROUND OF THE INVENTION

1. Field of the invention

The present invention relates to an adaptive multimedia processor and an adaptive data processing method. More particularly, the present invention relates to a structure of an adaptive multimedia image processor and a method for implementing an adaptive data processing algorithm, which can reproduce various multimedia input data using different compression formats of heterogeneous devices and homogeneous devices in the same device in real time.

2. Description of the Prior Art

As generally known in the art, a multimedia processor, a dedicated multimedia codec Applicable Specific Integrated Circuit (ASIC), or a System on Chip (SoC) mixedly using the multimedia processor and a dedicated multimedia codec Internet Protocol (IP), has been used for a high capacity multimedia data processing.

In reproducing various multimedia input data using different compression formats in heterogeneous devices and homogeneous devices, the compatibility may lack between the compression formats, which requires a cumbersome job of converting multimedia formats with an assistance from a different device such as a Personal Computer (PC) and then transferring the format-converted data to a device for reproducing the converted data. For example, in reproducing camcorder multimedia data in a mobile phone, it is impossible to directly reproduce the camcorder multimedia data in the mobile phone due to lack of the compatibility between the data. Further, it is required to convert a format of the camcorder multimedia data to a format for a mobile phone with an assistance from a PC or a base station and then transfer the format-converted data to the mobile phone in order to reproduce the converted data in the mobile phone.

FIG. 1 is a block diagram of a conventional SoC for reproducing various multimedia input data using different compression formats of heterogeneous devices, in which a multimedia processor and a dedicated codec IP are mixedly used with each other.

In reproducing multimedia data for a camcoder 101 in a mobile phone, multimedia data formats between heterogeneous devices are different from each other and the compatibility lacks between the formats, so that it is impossible to directly reproduce the multimedia data for a camcorder 101 in the mobile phone. Therefore, a format of the multimedia data 101 for a camcorder is converted to a format of multimedia data for 103a mobile phone through a PC 102, which is an intermediate device. Then, after PC 102 transfers the format-converted multimedia data 103 for a mobile phone to the mobile phone to reproduce the converted data, the multimedia data 103 for a mobile phone can be reproduced in the mobile phone.

FIG. 2 is a block diagram of a conventional SoC for reproducing various multimedia input data using different compression formats of homogeneous devices, in which a multimedia processor and a dedicated codec IP are mixedly used with each other.

The homogeneous devices, for example, a first mobile phone and a second mobile phone, may use different compression formats, respectively. For example, the first mobile phone can support only VC-1 video data as multimedia data 201 for a first mobile phone and the second mobile phone can support only a H.264 codec as multimedia data 203 for a second mobile phone.

When the multimedia data 201 for a first mobile phone and the multimedia data 203 for a second mobile phone are different from each other, a conversion of a multimedia data format between homogeneous devices is required in order to enable the multimedia data 201 for a first mobile phone to be reproduced in the second mobile phone. Accordingly, after converting the multimedia data 201 for a first mobile phone, such as VC-1 video data, to the multimedia data 203 for a second mobile phone, such as H.264 video data, a base station 202 can transmit the converted multimedia data to the second mobile phone. Then, the second mobile phone can reproduce the multimedia data 203 for a second mobile phone.

In reproducing various multimedia input data using different compression formats in the conventional SoC in which the multimedia processor is mixedly used with the dedicated codec IP, when the compression formats are not available compression formats that can be reproduced by a device, the device cannot directly reproduce the multimedia input data. Accordingly, the device can reproduce the multimedia input data only after the PC or the base station converts the formats of the data to formats that can be reproduced in the device and then the device downloads the converted data through a wireless transmission or a cable connection, which causes an inconvenience. Specifically, in a situation in which the PC or the base station is not available, there is a disadvantage in that it is impossible to reproduce data of heterogeneous formats and it is difficult to reproduce the data in real time.

### SUMMARY OF THE INVENTION

As described above, in the conventional Soc in which the multimedia processor is mixedly used with the dedicated codec IP, a data format conversion by a surrounding base station or a PC is necessary in order to reproduce various multimedia input data using different compression formats. This data format conversion is cumbersome job and makes it difficult to reproduce the multimedia input data in real time.

Accordingly, the present invention has been made to solve the above-mentioned problems occurring in the prior art, and the present invention provides a structure of an adaptive multimedia processor and a method for implementing an adaptive algorithm, which can reproduce various multimedia input data using different compression formats in the same device in real time without a format conversion of the data in a base station or a PC by converting the multimedia input data which cannot be supported by the device, to the multimedia input data which can be supported by the device, by using a main processor, codec hard IPs, a memory, surrounding devices, a bit stream analyzer, and a learning device which can execute a learning algorithm.

In accordance with an aspect of the present invention, there is provided an adaptive multimedia processor including: a bit stream analyzer for analyzing bit stream information of multimedia data; and a bit stream learning device for converting multimedia data having a format which cannot be reproduced in a device, to multimedia data having a format which can be reproduced in a device, by executing a learning algorithm, based on an analysis by the bit stream analyzer.

The adaptive multimedia processor further includes a codec hard IP for compressing and decompressing the multimedia data. Further, the adaptive multimedia processor further includes a memory for storing the multimedia data. Further, the bit stream analyzer analyzes a bit stream head to determine whether the multimedia data have a format, which can be reproduced in the device.

The learning algorithm refers to a supervised learning algorithm or an unsupervised learning algorithm. Further, the learning algorithm refers to a learning algorithm combining a supervised learning and an unsupervised learning.

In accordance with another aspect of the present invention, there is provided a method for processing adaptive data, the method including the steps of: receiving multimedia data; analyzing bit stream information of the multimedia data; determining whether the multimedia data have a format, which can be reproduced in a device, based on an analysis of the bit stream information; converting multimedia data having a format which cannot be reproduced in the device, to multimedia data having a format which can be reproduced in a device, through an execution of a learning algorithm; and reproducing a converted multimedia data.

The learning algorithm includes a supervised learning algorithm and an unsupervised learning algorithm. Further, the bit stream information refers to information stored in a bit stream head.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a conventional SoC for reproducing various multimedia input data using different compression formats of heterogeneous devices, in which a multimedia processor and a dedicated codec IP are mixedly used with each other;

FIG. 2 is a block diagram of a conventional SoC for reproducing various multimedia input data using different compression formats of homogeneous devices, in which a multimedia processor and a dedicated codec IP are mixedly used with each other;

FIG. 3 is a view schematically illustrating a structure of an adaptive multimedia processor according to an embodiment of the present invention; and

FIG. 4 is a flowchart illustrating a method for implementing an adaptive algorithm of an adaptive multimedia processor according to an embodiment of the present invention.

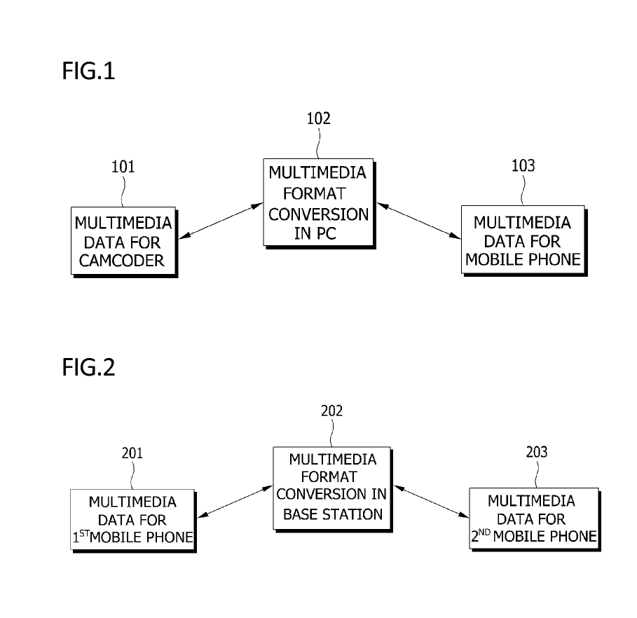

### DETAILED DESCRIPTION OF THE EXEMPLARY EMBODIMENTS

Hereinafter, an exemplary embodiment of the present invention will be described with reference to the accompanying drawings. A construction of the present invention and operation and effects according to the construction will be understood by the detailed description below.

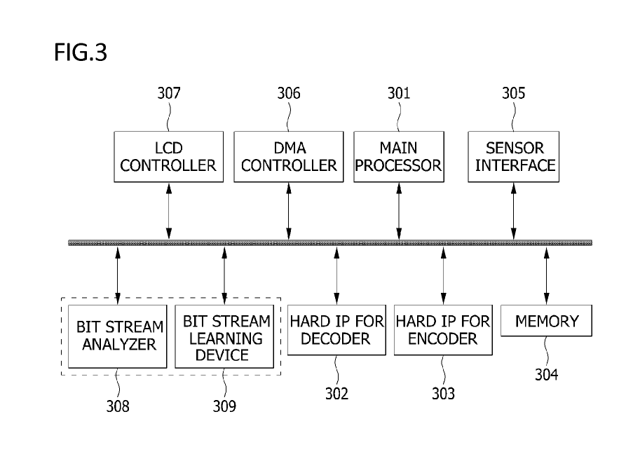

FIG. 3 is a view schematically illustrating a structure of an adaptive multimedia processor according to an embodiment of the present invention. Referring to FIG. 3, the adaptive multimedia processor includes a main processor 301, codec hard IPs including a hard IP 302 for a decoder and a hard IP 303 for an encoder, a memory 304, a bit stream analyzer 308, a bit stream learning device 309, and peripheral devices of various kinds.

The main processor 301 executes a main program of the adaptive multimedia processor and controls each of the blocks.

The memory 304 includes various internal memories, which can be a Static Random Access Memory (SRAM), a Synchronous Dynamic Random Access Memory (SDRAM), a flash memory, etc. The peripheral devices may include a sensor interface 305, a Direct Memory Access (DMA) controller 306, a Liquid Crystal Display (LCD) controller 307, a serial interface (not shown in FIG. 3), a parallel interface (not shown in FIG. 3), etc. The memory 304 and the peripheral devices of various kinds perform a function of storing multimedia data from the outside or transferring processed data to the outside.

The codec hard IPs including the hard IP 302 for a decoder and the hard IP 303 for an encoder compress and decompress high speed high volume multimedia data.

When various multimedia data using different compression formats are input into a multimedia processor, the bit stream analyzer 308 determines whether the input multimedia data can be reproduced in a device or cannot be reproduced in the device by analyzing a bit stream head.

The bit stream device 309 performs a supervised learning algorithm, an unsupervised learning algorithm, or a learning algorithm combining a supervised learning and an unsupervised learning. When the data analyzed by the bit stream analyzer 308 cannot be reproduced in the device, the bit stream device 309 converts a format of the multimedia data by performing the learning.

The supervised learning algorithm refers to an algorithm used for data classification and data prediction in a state in which advance information on an object to be classified has been recognized. When the bit stream learning device 309 is aware of a database (DB) with regard to different data formats in advance, the bit stream learning device 309 can convert a multimedia format by using the supervised learning algorithm.

Meanwhile, the unsupervised learning algorithm refers to an algorithm used for data classification and data prediction in a state in which advance information on an object to be classified has not been recognized. When the bit stream learning device 309 is not aware of information with regard to different data formats in advance, the bit stream learning device 309 can convert a multimedia format by using the unsupervised learning algorithm. For example, although the bit stream learning device 309 is not aware of information with regard to a data format, it can divide and predict data through an association rule, a clustering algorithm, etc., thereby implementing the unsupervised learning algorithm.

Further, the bit stream learning device 309 may use a method of selecting one of the supervised learning and the unsupervised learning according to the existence or absence of the advance information to convert a multimedia format by using the algorithm combining the supervised learning and the unsupervised learning.

As illustrated in FIG. 3, the bit stream analyzer 308 and the bit stream learning device 309 may be implemented separately or as one integrated module.

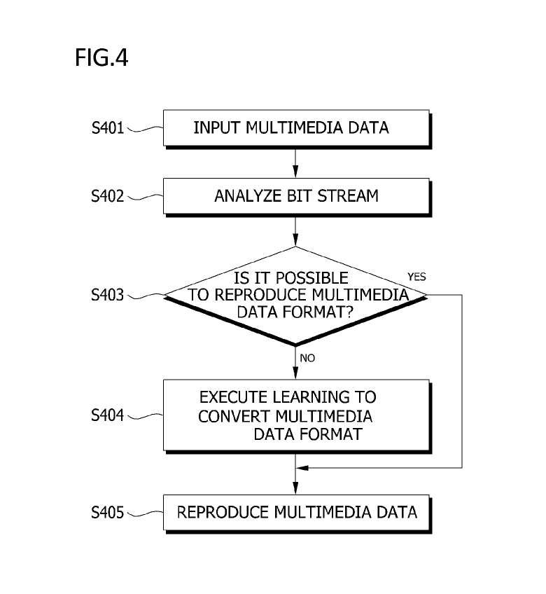

FIG. 4 is a flowchart illustrating a method for implementing an adaptive algorithm of an adaptive multimedia processor according to an embodiment of the present invention. The flowchart shown in FIG. 4 describes an adaptive algorithm of an adaptive multimedia processor, which can reproduce various multimedia input data using different compression formats in the same device in real time without an aid of a base station or a PC by converting the multimedia input data which can be supported by the device, to the multimedia input data which cannot be supported by the device.

First, the multimedia input data having various compression formats are received from the outside (step S401). When the multimedia data are input, the multimedia data may be stored in a memory 304.

After the multimedia data are stored in the memory 304, the bit stream analyzer 308 analyzes bit stream information of the input multimedia data (step S402). Here, the bit stream information refers to information stored in a bit stream head.

Next, according to the bit stream information analyzed by the bit stream analyzer 308, a main processor determines whether the multimedia data can be reproduced in a device or not (step S403).

If the multimedia data can be reproduced in the device, the device directly reproduces the multimedia data without any data processing (step S405).

If the multimedia data cannot be reproduced in the device, the bit stream learning device 309 converts a format of the data to a multimedia format which can be reproduced in the device, by using the supervised learning algorithm or the unsupervised learning algorithm, or using both the supervised learning algorithm and the unsupervised learning algorithm (step S404) and then the multimedia data are reproduced (step S405).

According to the present invention, it is possible to reproduce various multimedia input data using different compression formats in the same device in real time without an aid of a base station or a PC by converting multimedia input data which cannot be supported by the device to multimedia input data which can be supported by the device by using a main processor, codec hard IPs, a memory, surrounding devices, a bit stream analyzer and a learning device.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An adaptive multimedia processor comprising:
a bit stream analyzer for analyzing bit stream information of multimedia data; and
a bit stream learning device for converting multimedia data having a format which cannot be reproduced in a device, to multimedia data having a format which can be reproduced in the device, by executing a learning algorithm, based on an analysis by the bit stream analyzer.

2. The adaptive multimedia processor as claimed in claim 1, further comprising a codec hard IP for compressing and decompressing the multimedia data.

3. The adaptive multimedia processor as claimed in claim 1, wherein the bit stream analyzer analyzes a bit stream head to determine whether the multimedia data have a format which can be reproduced in the device.

4. The adaptive multimedia processor as claimed in claim 1, wherein the learning algorithm is a supervised learning algorithm.

5. The adaptive multimedia processor as claimed in claim 1, wherein the learning algorithm is an unsupervised learning algorithm.

6. The adaptive multimedia processor as claimed in claim 1, wherein the learning algorithm is a combination of a supervised learning and an unsupervised learning.

7. The adaptive multimedia processor as claimed in claim 1, further comprising a memory for storing the multimedia data.

8. A method for processing adaptive data, the method comprising:
receiving multimedia data;
analyzing bit stream information of the multimedia data;
determining whether the multimedia data have a format which can be reproduced in a device, based on an analysis of the bit stream information;
converting multimedia data having a format which cannot be reproduced in the device, to multimedia data having a format which can be reproduced in the device, through an execution of a learning algorithm; and
reproducing a converted multimedia data.

9. The method as claimed in claim 8, wherein the learning algorithm comprises a supervised learning algorithm and an unsupervised learning algorithm.

10. The method as claimed in claim 8, wherein the bit stream information is information stored in a bit stream head.
